(19) United States
(12) Patent Application Publication
(10) Pub. No.: US 2015/0040976 A1
(43) Pub. Date: Feb. 12, 2015

(54) METHOD FOR PREPARING SOLAR PAINT AT ROOM TEMPERATURE FOR DYE SENSITIZED SOLAR CELLS FOR WINDOW PANES AND FLEXIBLE SUBSTRATES

(71) Applicant: COUNCIL OF SCIENTIFIC AND INDUSTRIAL RESEARCH, New Delhi (IN)

(72) Inventors: Shruti Anil Agarkar, Pune (IN); Vivek Vishnu Dhas, Pune (IN); Subas Muduli, Pune (IN); Satishchandra Balkrishna Ogale, Pune (IN)

(21) Appl. No.: 14/370,914

(22) PCT Filed: Jan. 7, 2013
(86) PCT No.: PCT/IN2013/000015

§ 371 Date: Jul. 7, 2014

(30) Foreign Application Priority Data
Jan. 5, 2012 (IN) 36/DEL/2012

(51) Int. Cl. H01G 9/20; H01G 9/00

(52) U.S. Cl. CPC H01G 9/2031; H01G 9/2059; H01G 9/0029
USPC 136/256; 136/263; 427/74

(57) ABSTRACT

The present invention discloses a room temperature process for the fabrication of dye sensitized solar cells (DSSCs). Particularly, the invention discloses a room temperature process for preparing easily curable, binder free titania based solar paint that gives a high conversion efficiency to be used in fabrication of DSSCs at room temperature.

### TECHNICAL FIELD OF THE INVENTION

The present invention relates to a room temperature process for the fabrication of dye sensitized solar cells (DSSCs). Particularly, the invention relates to a room temperature process for preparing easily curable, binder free titania based solar paint that gives a high conversion efficiency, to be used in fabrication of DSSCs at room temperature.

### BACKGROUND AND PRIOR ART OF THE INVENTION

Developing affordable and highly efficient photovoltaics technologies has always been a cherished goal of materials scientists and the device community. Exploring non-silicon alternatives based on novel scientific opportunities afforded by nanotechnology (the so-called third generation cells) has gained significant momentum in this respect during the past two decades. Towards this end, the discovery of Dye Sensitized Solar Cells (DSSC) in 1991 by Gratzel and coworkers stands out, as one of the front runners in view of the basic novelty of the concept derived from the nature's principles and the chemical way of assembling the cell architecture which enables facile and cost effective processing. The significant collective efforts of the scientific community over the past 20 years have not only pushed the efficiencies higher but have brought out several new ways of making robust and durable DSSCs fairly affordable and with good efficiencies. This has included intense work on various inorganic oxide morphologies, sensitizers, co-adsorbers, co-sensitization schemes, new counter electrodes, new redox electrolytes etc.

For large scale commercial implementation of the technology however, it is considered essential that the cells are made at low temperature which could allow the corresponding architecture to be configured on polymeric flexible substrates. The main hurdle in this context is the temperature of cell processing since such flexible polymer based substrates are not stable above −150° C. This temperature is considered to be low for establishing good necking between the nanoparticles of inorganic materials such as titania used to provide the much needed efficient electron transporting backbone to control the adverse consequences of carrier recombination for cell efficiency. Hence strategies are needed for achieving better necking that avoid exceeding the highest processing temperature of about 150° C., yet realizing good efficiency. The dream is of course to be able to develop processes for fully room temperature fabrication of cells, albeit with somewhat lower efficiency than the cells processed at higher temperatures on hard substrates such as FTO/Glass.

Arakawa et al in US 2009/0114277 disclose a room temperature production process for a photoelectrode to be used in a DSSC including a process of pressing at a pressure from 4 MPa or higher to 500 MPa or lower.

References may be made to journal, ACS Nano, 2012, Vol, 6, 865-872; wherein Kamat and coworkers in Sun-Believable Solar Paint disclose a Transformative One-Step Approach for Designing Nanocrystalline Solar Cells, describes “Sun believable” paint employing CdS/CdSe quantum dots, although their cells are processed at a rather high temperature of 200° C. and the efficiency achieved is about 1%.

Liu et al. in “Room temperature fabrication of porous ZnO photoelectrodes for flexible dye-sensitized solar cells.” Chem. Commun., 2007, 2847-2849 speaks on the use of ammonia treatment for surface activation of ZnO photo-electrodes to achieve an efficiency of 4.5% under room temperature processing. Unfortunately ZnO is not known to be a very stable system in a dye environment and it is highly desirable to find room temperature processing strategy for the robust titania system.

Processes known in the prior art for preparation and coating of a solar paint on a surface includes a combination of following steps:

a. preparing the paint;

b. applying the coating on a surface;

c. heat treating the coating of step (b) to increase adhesion to the substrate (so as to eventually reduce impedance and increase efficiency). (B. O'Regan and M.

Gra`tzel, Nature, 1991, 353, 737-740; S. Muduli, O. Game, V. Dhas, A. Yengantiwar and S. B. Ogale, Energy, Environ. Sci., 2011, 4, 2835-2839).

d. post TiCl₄ treatment of step (c) to improve inter-particle necking (so as to eventually reduce impedance and increase efficiency); and (B. O'Regan and M. Gra`tzel, Nature, 1991, 353, 737-740;. S. Muduli, O. Game, V. Dhas, A. Yengantiwar and S. B. Ogale, Energy, Environ. Sci., 2011, 4, 2835-2839).

e. Sensitizing the coating of step (d) by soaking in 0.5 mill molar ethanolic solution of N719 Dye for 24 hrs.

Heat treatment of step (c) includes, annealing at 450oC for 1 hr. Post TiCl4 treatment is dipping the annealed coating in 40 mili molar TiCl4 Solution for half an hour at 70oC and then washed with water and ethanol 3 times and again annealed it at 450° C. for half an hour.

It is evident from the above that the prior art processes involves multi steps carried at higher temperatures and hence cumbersome. It is further evident from the art that the coating steps as mentioned above require high temperature treatments. Thus the prior arts reveal a gap in the technology available till date that there is no simple, room temperature process available for preparing titania based solar paint for fabricating DSSC at room temperature, such that the disadvantages of ZnO are overcomed and the process provides a directly paintable composition with improved efficiency.

### OBJECTS OF THE INVENTION

Thus the object of the invention is to provide a room temperature process of formulating titania-nanoparticle based paste and fabricate DSSC, also at room temperature resulting in improved efficiencies of the DSSCs as compared to those reported for titania based pastes made and processed at higher temperatures. Another object of the invention is to provide titania nanoparticle based solar paint for easy application on hard as well as flexible substrates to obtain improved conversion efficiency.

### BRIEF DESCRIPTION OF FIGURES

FIG. 1 summarizes the role of the tBA(t-butyl alcohol):TiO₂ ratio on the solar conversion efficiency along with the confocal microscope images of the respective cases. tBA:TiO₂ ratio 2 shows cracks in the film which justifies its low efficiency. tBA:TiO₂ ratio 4 and 6 have similar nature but on close examination tBA:TiO₂ ratio 6 shows wider cracks as compared to ratio 4. tBA:TiO₂ ratio 8 has pin holes which decrease its efficiency further.

FIG. 2A shows the I-V data (current density vs voltage) for three different cases (tBA: TiO₂ changing from 2 to 6 with all cells processed fully at room temperature.

FIG. 2B depicts incident photon to current conversion efficiency (IPCE) data for tBA:TiO2 ratio of (a) 1:2 (b) 1:4 and (c) 1:6.

FIG. 3: depicts Fourier transform infrared spectroscopy (FTIR) data of the solar paint taken in the ATR (Attenuated Total Reflection) mode at different time intervals.

FIG. 4: depicts the I-V data for films of different thicknesses.

FIG. 5 depicts I-V data of cells made from solar paint at room temperature compared with those made from solar paint and annealed at 150° C. and 450° C.

FIG. 6 (A) depicts I-V data and inset of actual images of flexible DSSC using solar paint and FIG. 6(B) depicts I-V data and inset of brush painted DSSC using solar paint.

FIG. 7 depicts I-V data for plot for films with local and U-type Aluminum (Al) contacts with tBA:TiO2 ratio 4 and thickness −12 microns.

### SUMMARY OF THE INVENTION

Accordingly, present invention provides a room temperature process for the preparation of easily curable, binder free titania nanoparticle based solar paint useful for fabricating dye sensitized solar cell at room temperature in the range of 20 to 40° C. and the said process comprising the steps of:
a. preparing a paste of titania in a mixture of t-butyl alcohol and water, wherein the ratio of t-butyl alcohol to titania ranges from 1:0.1 to 10:1 followed by stirring at room temperature in the range of 20 to 40° C. for period in the range of 5-6 hours and maintaining the pH at 2 using an acid;
b. applying the paste obtained in step (a) onto a substrate at room temperature in the range of 20 to 40° C. by known technique to obtain films of a thickness in the range of 10 to 12 μm; and
c. soaking the film of step (b) in ethanolic solution of dye to obtain dye sensitized TiO2 photoanode.

In an embodiment of the present invention, dye used is selected form Ruthenium-based N719 dye, Ruthenium-based N3 dye, black dye or organic dye.

In yet another embodiment of the present invention, the substrate is hard or flexible substrate selected from FTO/glass substrates, Indium tin oxide coated poly ethylene terpthalate (ITO/PET), glass window panes, polymer or plastic sheets with conducting overlayers and metal ribbons.

In yet another embodiment of the present invention, the ratio of t-butyl alcohol to Titania in the paste is selected from the group consisting of 2:1, 4:1 or 6:1.

In yet another embodiment of the present invention, the acid used is a mineral acid.

In yet another embodiment of the present invention, a dye-sensitized solar cell comprising a hard or flexible substrate coated with a film of easily curable, binder free titania nanoparticle solar paint with average particle size of 20-30 nm in diameter of thickness in the range of 10 to 12 μm, prepared by the above mentioned process at room temperature in the range of 20 to 40° C. and a monolayer of adsorbed dye molecules on titania nanoparticles.

In yet another embodiment of the present invention, said dye-sensitized solar cell has a single point edge contact or optionally may have U-type Al contacts. In yet another embodiment of the present invention, conversion efficiency of the said solar paint is in the range of 3 to 5% in fabrication of DSSCs.

In yet another embodiment of the present invention, the dye-sensitized solar cell further comprises a light scattering layer.

In yet another embodiment of the present invention, said process is characterized in avoiding heat treating and post TiCl₄ treatment step.

### DETAILED DESCRIPTION OF THE INVENTION

In an aspect, the present invention provides a room temperature process for the preparation of binder free, easily curable titania based solar paint for fabricating dye sensitized solar cells (DSSCs) at room temperature, with improved conversion efficiency.

In another aspect, the invention provides a titania-nanoparticle-based solar paint prepared by the process of instant invention which can be applied on hard as well as flexible substrates such as FTO/glass substrates, Indium tin oxide coated poly ethylene terpthalate ITO/PET, window panes, polymer or plastic sheets with conducting overlayers and metal ribbons without any heat treatment or a light harvesting overlayer with improved conversion efficiency.

The paint can be applied easily either by doctor blading or by simple brush painting or screen painting. The titania -nanoparticle based solar paint cures quite quickly making the cell fabrication process time saving.

In the process, TiO2 : tertiary butyl alcohol (tBA) weight ratio , the film thickness are optimized such that high quality adherent films with good transport properties and efficiency, dye loading and improved incident photon to current conversion efficiency (IPCE) are achieved. A conversion efficiency of 3-5% is achieved in the present invention.

The titania nano particles film was sensitized with a dye namely Ruthenium N719 dye. A conversion efficiency of 3-5% is achieved in the present invention. In another aspect, the present invention provides a dye-sensitized solar cell comprising a hard or flexible substrate coated with a film of easily curable, binder free titania nanoparticle solar paint (with particles of size 20-30 nm in diameter) of thickness of not greater than 10 pm, prepared by the process of the instant invention at room temperature, and a monolayer of adsorbed dye molecules on titania nanoparticles. The dye sensitized solar cell of the present invention has a single point edge contact and may optionally have U-type Al contacts for enhanced efficiency.

A conversion efficiency of about 3.6% is achieved on (fluorine doped tin oxide) FTO/glass substrate without any heat treatment or adding light harvesting layer.

In another aspect, the present invention provides semi -transparent flexible ITO/PET substrate including use of a light harvesting layer to obtain substrate efficiency of 2.4%

In yet another aspect, the efficiency (n (%)) is further improved to 5% by improving the charge collection efficiency by making Aluminum U-type contacts by thermal evaporation. This aluminum metal contacts decrease the series resistance of cell thus improve the charge collection.

The improved conversion efficiency achieved according to the process of the invention clearly establishes that the instant process results in good adhesion and contact with the substrate. Also, the instant invention demonstrates a room temperature process with no external pressure, no external energy supplements or chemical treatment and yet achieves good inter particle necking in the film, which has not been demonstrated in the prior art.

Titanium dioxide, TiO2, is a white semiconductor which is not sensitive to visible light. Hence, another material is used to sensitize the TiO2 (titania) particles; a layer of dye molecules is coated on titania particles in order to absorb visible light. As seen from above there is no simple, room temperature process available for preparing titania based solar paint to fabricate a DSSC at room temperature.

Accordingly, the present invention discloses a room temperature process for the preparation of easily curable, binder free titania nanoparticle based solar paint for fabricating dye sensitized solar cells, at room temperature. The process is cheap, efficient and requires less time as compared to the processes known in the art.

The present inventors observed that in order to achieve better necking between the particles which in turn improves the fill factor (FF) and the open circuit voltage (Va) it is necessary to optimize the ratio of alcohol to TiO2 (titania) as well as the film thickness of titania electrode.

Thus, in an embodiment, the room temperature process for the preparation of easily curable, binder free titania nanoparticle based solar paint with conversion efficiency of 3-5% that can be used to fabricate DSSCs include the following steps;
a. preparing a paste of titania in an alcohol and water, wherein the ratio of titania to alcohol ranges from 1:0.1 to 10:1, stirring at room temperature for 5-6 hours and maintaining the pH-2 using an acid;
b. applying the paste obtained in step (a) onto a substrate by known technique to obtain films of a thickness in the range of 10 to12 μm at room temperature; and
c. soaking the film of step (b) in alcoholic solution of 0.5 mM Ruthenium based N719 dye for about 24 hours to obtain dye sensitized TiO2 photoelectrode.

The alcohol is selected from lower alcohols, preferably t-butyl alcohol (tBA). The titania for the process of the invention is selected from anatase or rutile or combinations thereof and is in the form of nanopowder with different morphologies like spheres(200 nm), nano leaves (20-30 nm) or mixture of particles(8-10 nm) and nanoleaves(20-30 nm). The film thickness is in the size range of 10-1000 nm. The temperature is room temperature ranging from 20-40° C. The acid is selected from any mineral acid to maintain the pH approximately at 2. The use of H+ions by the addition of acid (pH nearly 2) during the formation of the binder-free paste is to catalyze this TiO2 network formation in the first step with water obtained as a side product. Also the binder free paste thus obtained with proper viscosity which is formed in a few hours compared to the prior art reports where 4-5 days is typically required. The next step builds on the first by the formation of a tBA-water complex, which occurs as soon as the side product water molecules surround the excess tBA molecules. In all cases the water quantity was half the quantity of tBA and hence the complex can therefore be easily and efficiently removed at room temperature by evaporation.

The paint can be applied easily either by doctor blading or by simple brush painting or screen painting. The titania -nanoparticle based solar paint cures quite quickly making the cell fabrication process time saving.

The titania-nanoparticle based solar paint can be applied on hard as well as flexible substrates such as FTO/glass substrate, Indium tin oxide coated poly ethylene terpthalate ITO/PET, polymer or plastic sheets and metal ribbons without any heat treatment to give good adhesion with these substrates. This can be easily used in Smart windows which are transparent conducting substrates which can be used to generate electricity. This paint can be used as a light absorber layer after coating with suitable dye to generate electricity.

The titania nano particles film was coated with a sensitizing dye namely Ruthenium based N719 dye.

According to the process, titania in nanopowder form is added to a mix of t-butyl alcohol and water at room temperature, where the ratio of tBA: TiO2 ranges from 1:0.1 to 10:1. This is followed by addition of mineral acid, preferably nitric acid and stirred for 5-6 hours to form a paste. The paste is coated onto a suitable substrate to obtain films of a thickness of not greater than 10 _{N}m at room temperature. The film is further soaked in alcoholic solution of 0.5 mM Ruthenium-based N719 dye to obtain TiO2 sensitized photoelectrode.

The role of H+ ions is to catalyze TiO2 network formation in the first step with water obtained as a side product. A uniform viscous paste is formed in a few hours as compared to the earlier reports where 4-5 days is typically required. The next step builds on the first by the formation of a tBA-water complex, which occurs as soon as the side product water molecules surround the excess tBA molecules.

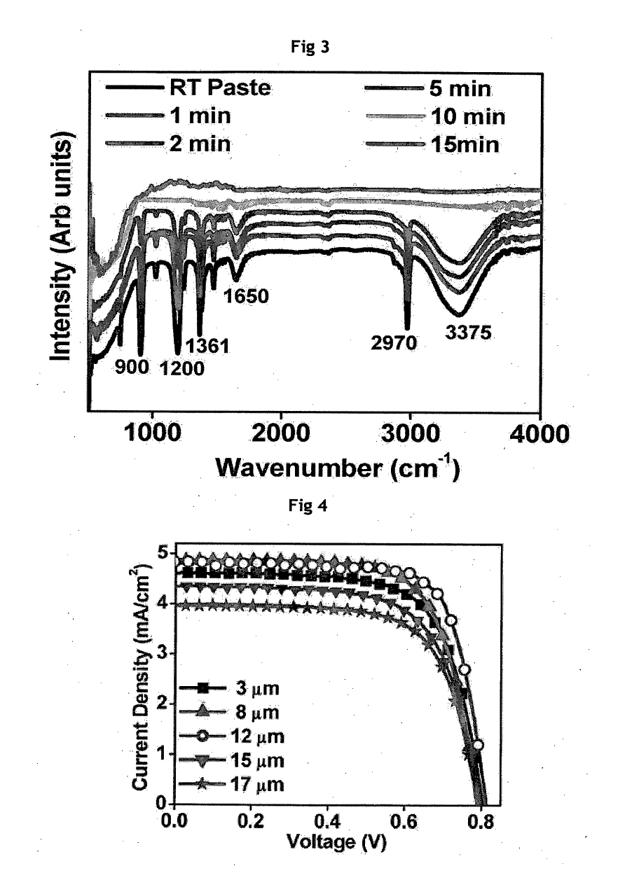

In all cases the water quantity is observed to be half the quantity of tBA due to which the complex can easily and efficiently be removed at room temperature. Further, FIG. 3 shows FTIR data of the solar paint taken in the, ATR (Attenuated Total Reflection) mode at different time intervals. The paint thus formed shows characteristic peaks of tBA at 3375, 2970,1650, 1360, 1200 and 900 cm⁻¹ corresponding to OH bending, CH₃ anti symmetric stretching, OH bending, CH₃ deformation, C3C-O antisymmetric stretching and CH₃ rocking modes, respectively. These peaks begin to vanish quickly and progressively within a few minutes of forming film on the substrate and vanish completely after about 15 mins, suggesting that no organic matter remains in the film that produces high quality photoanodes at room temperature.

In an embodiment, the present invention provides the ratio of alcohol to TiO2 in ratio of 2:1, 4:1 and 6:1, preferably, 4:1.

In an embodiment, the present invention disclose a dye-sensitized solar cell comprising a hard or flexible substrate coated with a film of easily curable, binder free titania nanoparticle solar paint of average particles size 20-30 nm in diameter) of thickness of not greater than 10 μm, prepared by the process of the instant invention at room temperature, and a monolayer of adsorbed dye molecules on titania nanoparticles.

The dye sensitized solar cell of the present invention has a single point edge contact and may optionally have U-type Al contacts for enhanced efficiency.

The efficiency of the solar cells is tested under 1.5 A.M Solar Simulator (Newport) at 100 mW/cm².

The DSSC obtained by the process of the invention are tested for efficiency η (%) and other parameters as listed in Table 1.

TABLE 1
Solar Cell Parameters for different cases coated on FTO substrate

| | Open Circuit | Current Density | Fill Factor | Efficiency |
|---|---|---|---|---|
| tBA:TiO₂ | Voltage V_{oc} (V) | J_{sc} (mA/cm²) | FF (%) | η (%) |
| 2:1 | 0.77 | 3.82 | 68.74 | 2.5 |
| 4:1 | 0.81 | 4.82 | 73.76 | 3.6 |
| 6:1 | 0.78 | 4.88 | 70.1 | 3.3 |

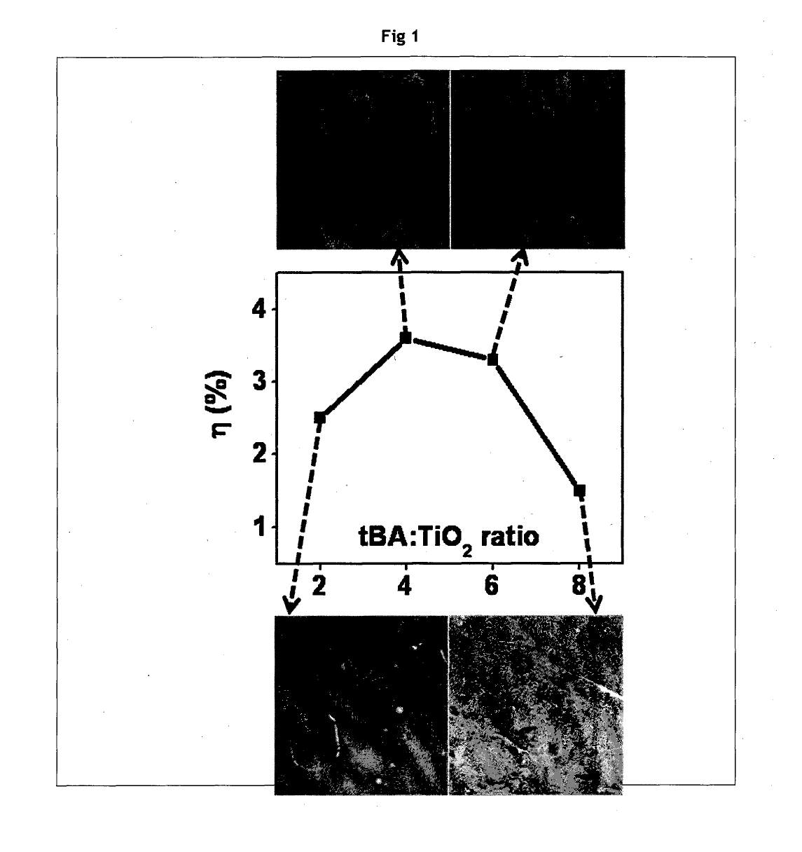

Referring to table 1 and FIG. 1, it is observed that the DSSC efficiency for the tba:titania ratio of 4:1 provides the best option at 3.6%, while there is a minimal drop in efficiency at a ratio of 6:1, when tested with reference to procedure listed in example 4. The titania composition prepared at room temperature and fabricated at room temperature as DSSC is devoid of light scattering layer.

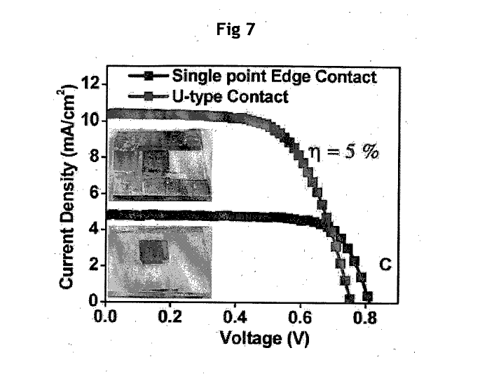

In an embodiment, efficiency (η(%)) is further improved upto 5% by improving the charge collection efficiency by making Aluminum U-type contacts by thermal evaporation as shown in FIG. 7 and table 4 in example below. This aluminium metal contacts decrease the series resistance of cell thus improve the charge collection.

In another embodiment of the invention the titania layer comprises a light scattering layer consisiting of an over layer of TiO₂ spheres of around 200 nm size. In yet another embodiment, the present invention provides semi-transparent flexible ITO/PET substrate including use of a light harvesting over layer to obtain substrate efficiency of 2.4%

Accordingly, a paste with tBA : TiO2 of ratio 4 :1 is tested on a semi-transparent flexible substrate (ITO-PET). A third layer of TiO2 spheres is used for light harvesting purposes. An efficiency of 2.4% is achieved on semi-transparent flexible ITO/PET substrate amenable to roll-to-roll processing. (FIG. 6A and 6B),

The DSSC performance can be enhanced, cost can be reduced and life of the solar cell can be enhanced through the following:
a) Adding light harvesting layer on the films surface or including light harvesting nanostructures inside the film,
b) Using solvent alternatives to enhance film quality, porosity, intergrain connectivity and morphology,
c) Using alternative oxides containing one, two or more cations selected from

ZnO, ZnFe2O4 and such like.
d) Using dye or quantum dot sensitizer alternatives,
e) Using solid state electrolytes or hole conductors including polymers,
f) Using cheaper catalysts for carrier regeneration selected from carbon nanotubes, graphene and carbon cloth,
g) Making composite pastes comprising of combination of metal oxide+dye/quantum dots or metal oxide+dye/quantum dot+electrolyte.

### EXAMPLES

Following examples are given by way of illustration therefore should not be construed to limit the scope of the invention.

Materials and Methods

Commercially available TiO2 (Degussa, P25) was procured and used for making the solar paint. The N719 dye and Fluorine doped SnO2 (FTO) electrodes (sheet resistance 15 ohm/square) were procured from Solaronix Co. The electrolyte used was 0.5 M 1, 2-dimethyl-3-propyl imidazolium iodide, 0.05 M Lil, 0.05 M 12, and 0.5 M 4-tert-butylpyridine in acetonitrile/valeronitrile 20 (v/v 1:1). The I-V characteristics were measured using a solar simulator (Newport) at 100 mW/cm2 (1 sun AM 1.5). Standard Silicon solar cell (SER NO. 189/PVM351) from Newport, USA was used as reference cell. The measurements of incident-photon-to-current conversion efficiency (IPCE) were done using Quantum Efficiency Setup (Newport Instruments). Diffused Reflectance Spectroscopy (DRS, Jasco V-570 spectrophotometer), Field emission scanning electron microscopy (FE-SEM 25 HITACHI 54800) and Electrochemical Impedance Spectroscopy (EIS, Autolab PGSTAT30 (Eco-Chemie)) were used to characterize the samples. The impedance measurements were performed at room temperature.

### Example 1

Preparation of Room Temperature TiO2 Photoanodes

The TiO2 paint was prepared using tertiary butyl alcohol (tBA) and water as solvents. Small amount of dilute acid (pH −2) was also added to this mixture. Various weight ratios of tBA: TiO2 were examined for optimization. After adding the desired amount of TiO2 to this solvent system it was continuously stirred for several hours to get a viscous paste. The TiO2 paint thus formed was coated on FTO/glass substrates as well as ITO-PET substrates using doctor blading technique. Application of the paint on the substrate by using a paint brush was also examined. Both the substrates were properly cleaned prior to paint application. TiO2 layers with different thicknesses were realized by multiple application of the paint. After drying the films at room temperature they were soaked in 0.5 mM N719 solution. Solar cells made with top electrode (Pt catalyst on FTO) and iodide-tri-iodide electrolyte were then made and tested for energy conversion efficiency and solar cell parameters. Impedance measurements were also carried out to examine the various resistances involved in the equivalent circuit.

### Example 2: DSSC of tba:titania 2:1

0.1 gm of titania-(Degusa P25, mixture of anatase and rutile, commercially available, nanopowder form) was taken with 0.22 gm of tba and 0.11 gm water. 0.1 ml dilute HNO₃ was added to the above mixture and stirred for 5-6 hours to form a paste. The paste was doctor blade coated on FTO-glass substrate to a thickness of 10 μm

### Example 3: DSSC of tba:titania 4:1

0.1 gm of titania-(Degusa P25, mixture of anatase and rutile, commercially available, nanopowder form) was taken with 0.44 gm of tba and 0.11 gm water. 0.1 ml dilute HNO₃ was added to the above mixture and stirred for 5-6 hours to form a paste. The paste was doctor blade coated on FTO-glass substrate to a thickness of 10 μm

### Example 4: DSSC of tba:titania 6:1

0.1 gm of titania-(Degusa P25, mixture of anatase and rutile, commercially available, nanopowder form) was taken with 0.66 gm of tba and 0.11 gm water. 0.1 ml dilute HNO₃ was added to the above mixture and stirred for 5-6 hours to form a paste. The paste was doctor blade coated on FTO-glass substrate to a thickness of 10 μm

### Example 5: DSSC of tba:titania 2:1

0.1 gm of titania-(Degusa P25, mixture of anatase and rutile, commercially available, nanopowder form) was taken with 0.22 gm of tba and 0.11 gm water. 0.1 ml dilute HNO₃ was added to the above mixture and stirred for 5-6 hours to form a paste. The paste was doctor blade coated on ITO/PET substrate to a thickness of 10 μm

### Example 6: DSSC of tba:titania 4:1

0.1 gm of titania-(Degusa P25, mixture of anatase and rutile, commercially available, nanopowder form) was taken with 0.44 gm of tba and 0.11 gm water. 0.1 ml dilute HNO₃ was added to the above mixture and stirred for 5-6 hours to form a paste. The paste was doctor blade coated on ITO/PET substrate to a thickness of 10 μm

### Example 7: DSSC of tba:titania 6:1

0.1 gm of titania-(Degusa P25, mixture of anatase and rutile, commercially available, nanopowder form) was taken with 0.66 gm of tba and 0.11 gm water. 0.1 ml dilute HNO₃ was added to the above mixture and stirred for 5-6 hours to form a paste. The paste was doctor blade coated on ITO/PET substrate to a thickness of 10 μm

### Example 8: Efficiency Testing of Solar Cells

Efficiency of these solar cells were tested under Solar Simulator (Newport) at 100 mW/cm² (1 sun AM 1.5).

### Example 9: Studies of Solar Cell Parameters for Different Systems

a. I-V Data and IPCE Data for tBA : TiO2 ratio of (a) 2 (b) 4and (c) 6.

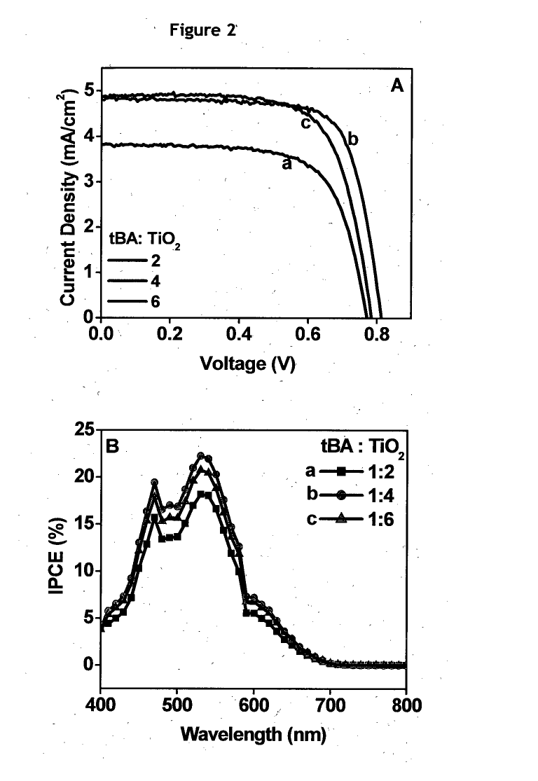

FIG. 2A shows the I-V data for three different cases (tBA: TiO2 ratio changing from 2 to 6) with all cells processed fully at room temperature. The data for optimization purposes were recorded only with a single point edge contact. The intermediate ratio of about 4 is seen to yield the highest efficiency of 3.6%. For the case with a ratio of 6 the efficiency is close to the best case i.e. 3.3% while for the case with a ratio of 2 the efficiency is low (2.5%). Although the dye loading for the case of the tBA: TiO₂ ratio of 2 is high the cause for low efficiency is the high degree of agglomeration in the TiO₂ network which affects the interconnectivity between the TiO₂ particulate system leading to higher degree of recombination. The case with an optimum tBA:Ti0₂ ratio of 4 dearly shows best efficiency due to improved necking between the particles. This in turn improves the fill factor (FF) and the open circuit voltage (V_{oc}) thereby increasing the efficiency. For the tBA: TiO₂ ratio of 6 the current is high but the V_{oc} and FF are seen to decrease due to scattering of incoming light by larger TiO₂ clusters. Due to the presence of larger clusters dye loading in this case is slightly higher than that for the case of tBA:TiO₂ ratio 4, but due to uneven nature of the film recombination increases drastically.

FIG. 2B shows the incident photon to current conversion efficiency (IPCE) data for different cases. It is seen that the IPCE for the case of ratio of tBA: TiO₂ of 4 system is the highest. This follows the same trend as seen for the I-V data where the current density is the maximum for the case of ratio 4.

b. The I-V Data for Films of Different Thicknesses

In addition to the ratio of solvent precursors, another important parameter that is required to be optimized for the best performance of the titania electrode for DSSC is film thickness. The effective optical absorption length, internal light scattering, series resistance etc. is observed to depend on the thickness and morphology in a fairly complex way. This is important for room temperature processing because the electronic grain connectivity, which is a critical parameter governing the optoelectronic performance has no thermal assistance in the present invention. Indeed the solvent evaporation under ambient temperature and pressure through an evolving grain constitution defines the final nano (micro) structure; its vertical (grain compaction and connectivity gradient) and lateral (stress, microcracking) uniformity. The lateral non-uniformity can result from drying shrinkage and the vertical one due to fluid density gradient. For very thin initial layers the effects of substrate-film interaction are important. Because of these factors a detailed study of film thickness dependence is conducted and the relevant data is given below.

The I-V data for films of different thicknesses for tBA : TiO2 ratio 4 are shown in FIG. 4 and in Table 2 below.

TABLE 2
I-V data with respect to film thickness

| Name | V_{oc} (V) | J_{sc} (mA cm⁻²) | FF (%) | η (%) |
|---|---|---|---|---|
| 3 μm | 0.80 | 4.62 | 68.7 | 2.5 |
| 8 μm | 0.79 | 4.80 | 70.1 | 2.7 |
| 12 μm | 0.81 | 4.82 | 73.8 | 3.6 |
| 15 μm | 0.79 | 4.30 | 67.3 | 2.3 |
| 17 μm | 0.78 | 3.96 | 69.3 | 2.2 |

It is seen from Table 2 that the 12 mm thick film gives the best result with better FF and Va. It may be noted that the current density however begins to drop for much thicker films.

c. The Effect of Annealing on the Solar Cell I-V

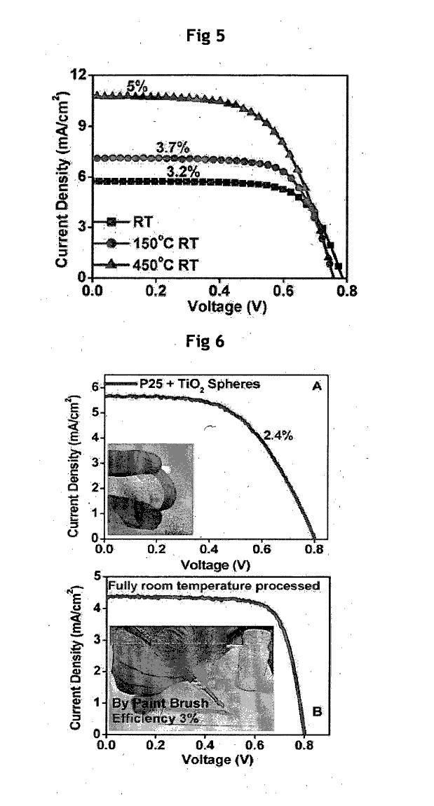

The effect of annealing on the solar cell I-V characteristics is given in FIG. 5 below: It is clear from the data shown in FIG. 5 that annealing at 150° C., which is also an acceptable temperature for some polymeric substrates, leads to a moderate enhancement in current density, while annealing at 450° C. leads to a significant enhancement, as expected, due to better sintering of grains and hence improvements in the solar cell quality factors.

d. I-V data w.r.t tBA : TiO2 ratio 4 pasted on a flexible substrate (ITO-PET) coated with a third layer of TiO2 spheres for light harvesting purposes.

A flexible substrate (ITO-PET) is pasted with tBA : TiO2 of ratio 4 and further coated with a third layer of TiO2 spheres for light harvesting purposes and 1-V spectra was recorded as shown in FIG. 6A and 6B. FIG. 6A shows a typical I-V curve for the same paste, which shows an efficiency of 2.4% with Jsc=5 mA cm²², Vα of 0.8.V and FF of 61%. The inset shows the actual image of the dye-loaded flexible photoanode. The use of a simple and common hand-based technique for paste application, namely a paint brush, was investigated. FIG. 6B shows the I-V curve obtained using such a brush-painted photoanode, while the inset depicts the actual process of painting. A fairly high efficiency of 3% is realized, opening the way to easily paint DSSC directly on to FTO-coated smart window panes.

e. Comparison of I-V Data for Films with Local and U-type Al Contacts with tBA: TiO2 of Ratio 4 and Thickness 12 Microns.

To reduce the internal series resistance contribution (Rs) attributable to the transport resistance of the bottom and top contacts, U-type vapor deposited aluminum metal pads were examined and the result is shown in FIG. 7 and Table 4 below.

TABLE 4
I-V data for solar cells with single edge
contact and U-type Al metal contacts

| Name | V_{oc} (V) | J_{sc} (mA cm⁻²) | FF (%) | η (%) |
|---|---|---|---|---|
| Single point edge contact | 0.81 | 4.8 | 73.7 | 3.6 |
| U type contact | 0.75 | 10.3 | 63.7 | 5.0 |

Although Va decreased slightly, the current density increased substantially as seen in Table 4. A conversion efficiency value of 5% was achieved.

The titania paste based DSSC prepared by the room temperature process of the invention finds wide scope of application as it can be directly applied on window panes. It reduces the time required for the manufacturing of cells, since annealing at 450° C. to remove the binder, which takes about 2 days is totally avoided. The invention provides a conversion efficiency of 3.6% on FTO/glass substrates (which can be used for window panes) without any heat treatment or a light and the same is enhanced to 2.4% with the addition of light harvesting layer. The current invention also achieves an efficiency of 1.5% on flexible ITO/PET substrate by a fully room temperature fabrication protocol invention thus demonstrate that purely chemical manipulation without any need to raise the temperature can enable realization of the goals collectively yielding fairly high solar energy conversion efficiencies.

1. A room temperature process for the preparation of easily curable, binder free titania nanoparticle based solar paint useful for fabricating dye sensitized solar cell at room temperature in the range of 20 to 40° C. and the said process comprising the steps of:
a. preparing a paste of titania in a mixture of t-butyl alcohol and water, wherein the ratio of t-butyl alcohol to titania ranges from 1:0.1 to 10:1 followed by stirring at room temperature in the range of 20 to 40° C. for period in the range of 5-6 hours and maintaining the pH at 2 using an acid;
b. applying the paste obtained in step (a) onto a substrate at room temperature in the range of 20 to 40° C. by known technique to obtain films of a thickness in the range of 10 to 12 μm; and
c. soaking the film of step (b) in ethanolic solution of dye to obtain dye sensitized TiO2 photoanode.

2. The room temperature process according to claim 1, wherein dye used is selected form Ruthenium-based N719 dye, Ruthenium-based N3 dye, black dye or organic dye.

3. The room temperature process according to claim 1, wherein the substrate is hard or flexible substrate selected from FTO/glass substrates, Indium tin oxide coated poly ethylene terpthalate (ITO/PET), glass window panes, polymer or plastic sheets with conducting overlayers and metal ribbons.

4. The room temperature process according to claim 1, wherein the ratio of t-butyl alcohol to Titania in the paste. is selected from the group consisting of 2:1, 4:1 or 6:1.

5. The room temperature process according to claim 1, wherein the acid used is a mineral acid.

6. A dye-sensitized solar cell comprising a hard or flexible substrate coated with a film of easily curable, binder free titania nanoparticle solar paint with average particle size of 20-30 nm in diameter of thickness in the range of 10 to 12 μm, prepared by the process of claim 1 at room temperature int in the range of 20 to 40° C. and a monolayer of adsorbed dye molecules on titania nanoparticles.

7. The dye-sensitized solar cell according to claim 6, wherein said dye-sensitized solar cell has a single point edge contact or optionally may have U-type Al contacts.

8. The room temperature process according to claim 1, wherein conversion efficiency of the said solar paint is in the range of 3 to 5% in fabrication of DSSCs.

9. The dye-sensitized solar cell according to claim 6, further comprising a light scattering layer.

10. The room temperature process according to claim 1, wherein said process is characterized in avoiding heat treating and post TiCl4 treatment step.
